(19) United States
(12) Patent Application Publication
(10) Pub. No.: US 2001/0034217 A1
(43) Pub. Date: Oct. 25, 2001

(54) SYSTEM AND METHOD FOR SELECTIVELY INTERCONNECTING AMPLIFIERS IN A COMMUNICATIONS DEVICE

(75) Inventors: ARAVIND LOKE, IRVINE, CA (US); MOHY F. ABDELGANY, IRVINE, CA (US); JAMES F. KAMKE, RIVERSIDE, IL (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(73) Assignee: MOHY, ABDELGANY F.

(21) Appl. No.: 09/222,672

(22) Filed: Dec. 29, 1998

(51) Int. Cl. H04B 1/04; H01Q 11/12

(52) U.S. Cl. 455/126; 455/253.2; 455/293; 455/311; 455/144; 455/234.1; 455/127; 455/115; 330/51; 330/151; 330/150; 330/310

(57) ABSTRACT

A wireless communications device includes an amplifier module configured to amplify a signal. The amplifier module includes a serial arrangement of amplifiers. Each of the amplifiers are designed to operate with increased efficiency for different power level ranges. The amplifiers are connectable via controllable switches. A controller, in communication with the controllable switches, selectively connects the amplifiers to increase the efficiency of the amplifier module.

### BACKGROUND OF THE INVENTION

1. Field of the Invention

The invention generally relates to electronic devices. More particularly, the invention relates to a communications device and an amplifier included therein.

2. Background

There is an ever present need to reduce the power consumption of electronic devices. For example, a laptop computer or a wireless phone typically includes a battery to store and provide electrical energy for the operation of the electronic device. A user can operate the electronic device through the battery when no other source of electrical energy is available, or when the user wants to be mobile. Batteries, however, store only a limited amount of electrical energy, which is consumed by the electronic device.

The batteries, thus, have to be recharged after the electronic device has been used for a certain time. The time interval between two subsequent charging events is expressed as operating time. In wireless phones, for example, the operating time can further be divided into a stand-by time and a talk time.

The user of a wireless communications device such as a mobile unit or a cellular phone typically desires to have an operating time, particularly a talk time, which is as long as possible. Additionally, the user generally expects the wireless device to be as small and as light as possible. Because the operating time is dependent from the capacity and, thus, usually from the size of the battery, small size, low weight, long operating time of the wireless device are often contradictory expectations.

To fulfill these expectations, manufacturers seek to increase the capacity of the batteries without increasing the size and weight of the batteries. In addition, manufacturers of wireless devices have developed wireless devices which operate at lower voltages, for example 3.3 volts, to increase the stand-by time and the talk time.

### SUMMARY OF THE INVENTION

One embodiment of the invention relates to a communications device having an amplifier module configured to amplify a signal. The amplifier module includes a serial arrangement of amplifiers. Each of the amplifiers are designed to operate with increased efficiency for different power level ranges. The amplifiers are connectable via controllable switches. A controller, in communication with the controllable switches, connects the amplifiers to increase the efficiency of the amplifier module.

The transmit power of a communication device typically varies depending on the transmit conditions, the proximity of the communications device to a base station, etc. For example, a communications device may transmit at maximum power when poor transmit conditions exist. In many devices, the output power amplifier is optimized to generate the maximum power output.

If the transmit conditions are favorable or if a communications device is near a base station, the communications device often transmits at less than the maximum output power. Statistically speaking, a communications device typically sends most of its operational life transmitting at less than maximum power. For example, in a code division multiple access (CDMA) cellular phone, most of the time the phone operates below the maximum power output level within a range from about −5 dBM (measured decibels referenced to a power of 1 milliwatt) to about + 8 dBm. Accordingly, one embodiment of the invention increases the output power efficiency when an electronic devices operates at a lower output power level.

Another embodiment of the invention relates to a wireless communications device comprising a modulator module configured to convert a baseband signal to a radio frequency signal. The wireless communications device further comprising an amplifier module which receives the radio signal and generates an amplified output signal.

The amplifier module further comprising a first amplifier with an input in communication with the radio frequency signal. The first amplifier is configured to generate a first amplified signal at increased efficiency in a first operational range.

The amplifier module further comprising a second amplifier with an input in communication with the output of the first amplifier. The second amplifier is configured to amplify the first amplified signal at increased efficiency in a second operational range to create a second amplified signal, wherein the second operational range is different than the first amplification range.

The amplifier module further comprising a third amplifier with an input in communication with the output of the second amplifier. The third amplifier is configured to amplify the second amplified signal at increased efficiency in a third operational range to create a third amplified signal, wherein the third operational range is different than the first and second operational ranges.

The amplifier module further comprising a first switch connected to the second amplifier and positioned to bypass the second amplifier. The amplifier module further comprising a second switch positioned to bypass the third amplifier.

The wireless communications device further comprising a bypass selector in communication with the first and second switches. The bypass selector is configured to output the first, second or third amplified signal as an amplified output signal. The wireless communications device further comprising a control module in communication with the bypass selector. The control module is configured to control the switch based on a desired operational level.

In one embodiment, the first operational range is between 29 dBm and 19 dBm. The second operational range is between 20 dBm and 9 dBm. The third operational range is between 10 dBm and −1 dBm.

In one embodiment, the bypass selector receives a digital control value. In another embodiment, the first amplifier further comprising two serially connected amplifiers.

Another embodiment of the invention relates to an amplification module comprising an input for receiving an input signal. The amplification module further comprising at least a first amplifier in communication with the input. The first amplifier is configured to amplify the input signal to generate a first amplified signal at increased efficiency within a first operational range.

The amplification module further comprising a first switch in communication with the first amplifier. The first switch is configured to output the first amplified signal as an amplified output signal.

The amplification module further comprising at least a second amplifier in communication with the first amplified signal. The second amplifier is configured to amplify the first amplified signal to generate a second amplified signal at increased efficiency in a second operational range, wherein the second operational range is different than the first operational range.

The amplification module further comprising a second switch in communication with the second amplifier. The second switch configured to output the second amplified signal as an amplified output signal.

In one embodiment, for example, the first amplifier operates with increased efficiency for an operational range between 29 dBm and 19 dBm. The second amplifier operates with increased efficiency for an operational range between 20 dBm and 9 dBm.

In another embodiment, the first switch places the first amplified signal into communication with the second amplifier. In yet another embodiment, the amplification module further comprising a selector wherein the selector is configured to selectively vary the first and second switches.

In one embodiment, the amplification module further comprising at least a third amplifier in communication with the second amplified signal. The third amplifier is configured to amplify the second amplified signal to generate a third amplified signal at increased efficiency in a third operational range, wherein the third operational range is different than the first and second operational ranges.

Another embodiment of the invention relates to an amplifier circuit comprising an input for receiving an input signal. The amplifier circuit further comprising at least a first amplifier in communication with the input. The first amplifier comprising structure which generates a first amplified signal at increased efficiency within a first operation range.

The amplifier circuit further comprising at least a second amplifier. The second amplifier comprising structure which amplifies the first amplified signal at increased efficiency within a second operational range to generate a second amplified signal.

The amplifier circuit further comprising at least one selector circuit in communication with the first and second amplifiers. The selector circuit configured to selectively generate an amplified output signal comprising at least a portion of the first or second amplified signal.

In one embodiment, the amplified output signal comprising a least a portion of the first and second amplified signals. In another embodiment, the input signal is approximately 800 megahertz. In yet another embodiment, the input signal is approximately 1900 megahertz. In an additional embodiment, the amplified output signal is a wireless communications signal.

In one embodiment, the amplified output signal is a cellular communications signal. In another embodiment, the amplified output signal is a Global System for Mobile Communications (GSM) communications signal. In yet another embodiment, the amplified output signal is a Personal Communications System (PCS) communications signal. In an additional embodiment, the amplified output signal is an Advanced Mobile Phone Systems (AMPS) communications signal.

One embodiment of the invention relates to an amplifier circuit that comprising a first means for amplifying an input signal to generate a first amplified signal at increased efficiency within a first operational range. The amplifier circuit further comprising a second means for amplifying the first amplified signal to generate a second amplified signal at increased efficiency within a second operational range. The amplifier circuit further comprising a third means for selectively enabling the output of at least one of the first and second amplified signals.

In one embodiment, the amplifier circuit further comprising a fourth means for selectively enabling at least one of the first and second amplifiers. In another embodiment, the fourth means enables at least one of the first and second amplifiers based on a desired operational range.

Another embodiment of the invention relates to a method of operating a wireless communications device comprising the acts of converting a baseband signal to a radio frequency signal and amplifying with a first amplifier, the radio frequency signal at increased efficiency in a first operational range to produce a first amplified signal. The method further comprising the act of amplifying with a second amplifier, the first amplified signal at increased efficiency in a second operational range to produce a second amplified signal, wherein the second operational range is different than the first amplification range.

The method further comprising the act of amplifying with a third amplifier, the second amplified signal at increased efficiency in a third operational range to produce a third amplified signal, wherein the third operational range is different than the first and second operational ranges. The method further comprising the act of selectively outputting based on a desired operational level, the first, second or third amplified signals as an amplified output signal.

In one embodiment, the first operational range is between 29 dBm and 19 dBm. The second operational range is between 20 dBm and 9 dBm. The third operational range is between 10 dBm and −1 dBm.

In another embodiment, the method further comprising the act of selectively activating the first, second or third amplifier. In yet another embodiment, the method further comprising the act of processing a digital control value to selectively activate at least one of the first, second or third amplifiers.

Another embodiment relates to a method of amplifying an input signal comprising the act of amplifying an input signal to generate a first amplified signal at increased efficiency within a first operational range. The method further comprising the act of amplifying the first amplified signal to generate a second amplified signal at increased efficiency in a second operational range, wherein the second operational range is different than the first operational range. The method further comprising the act of selectively enabling the output of at least one of the first and second amplified signals in response to a desired amplification level.

In one embodiment, the method further comprising the act of selectively activating at least one of the first and second amplifiers. In another embodiment the first operational range is between 29 dBm and 19 dBm and the second operational range is between 20 dBm and 9 dBm.

In another embodiment, the act of selectively enabling selects either the first or second amplified signal. In yet another embodiment, the act of selectively enabling combines the first and second amplified signals.

In one embodiment, the input signal is approximately 800 megahertz. In another embodiment, the input signal is approximately 1900 megahertz. In yet another embodiment, the amplified output signal is a wireless communications signal.

In one embodiment, the amplified output signal is a cellular communications signal. In another embodiment, the amplified output signal is a GSM communications signal. In yet another embodiment, the amplified output signal is a PCS communications signal. In an additional embodiment, the amplified output signal is an AMPS communications signal.

### BRIEF DESCRIPTION OF THE DRAWINGS

These and other aspects, advantages, and novel features of the invention will become apparent upon reading the following detailed description and upon reference to the accompanying drawings.

FIG. 1 is a schematic illustration of a wireless communications device cut away to show a portion of the motherboard.

FIG. 2 is an illustration of one embodiment of a transmit path within the wireless communications device shown in FIG. 1.

FIG. 3 is a schematic illustration of a first embodiment of a transmitter.

FIG. 4 is a schematic illustration of a transmitter module.

FIG. 5 is a schematic illustration of one embodiment of a power amplifier included in the transmitter module shown in FIG. 4.

FIG. 6 shows various graphs illustrating power efficiencies of power amplifiers.

FIG. 7 shows a flow chart of a control procedure.

### DETAILED DESCRIPTION OF THE PREFERRED EMBODIMENTS

FIG. 1 shows a wireless communications device 3 as an example for an electronic device. Other examples of electronic devices include wireless phones, cordless phones, mobile transmitters, stationary wireless transmitters, personal digital assistants, wireless modems, pagers, wireless fax machines, and other battery operated devices. It is contemplated that the invention is also applicable to a wide range of non-portable electronic devices such as modems, cable modems, fax machines, base stations, land-line based applications, computer network applications and the like. Further, it is contemplated that the invention is generally applicable to a wide range of battery operated devices. Hereinafter, one embodiment of the invention is described with reference to a cellular phone which is one embodiment of the wireless communications device 3.

The cellular phone operates within a mobile communications system. A mobile communications system, for example a code division multiple access (CDMA) system, is structured to have a variety of individual regions called cells, and to comprise a variety of fixed transceiver stations called base transceiver stations, and a plurality of mobile stations, the cellular phones. Usually, one base transceiver station defines one cell and handles telephone traffic to and from the cellular phones which are currently located in the cell.

The wireless communications device 3 is exemplary described as, but not limited to, a wireless phone for a CDMA system. Hereinafter, the wireless communications device 3 is referred to as the phone 3. A portion of the case of the phone 3 is cut away to show a motherboard 5 of the phone 3 with a transmitter module 1 positioned thereon. Although not shown in FIG. 1, those skilled in the art will appreciate that the phone 3 includes a plurality of other components and functional modules, such as the components included in a receive path and a transmit path. For example, the phone 3 further includes a central processing unit (CPU), an antenna 2, a display and a keypad.

In one embodiment, the transmitter module 1 is configured to emit radio frequency (RF) signals. The transmitter module 1 comprises an amplifier stage for amplifying the RF signals according to electrical characteristics such as a defined nominal effective radiated power (ERP). In cellular CDMA systems, the phones are grouped into three categories Class I, Class II and Class III having different ranges of effective radiated powers. For example, a Class I phone emits an effective radiated power of 1.25 watts to 6.3 watts and a Class III phone emits an effective radiated power of 0.2 watts to 1 watt. Further electrical characteristics are described in TIA/EIA/IS-98A, for example, in Table 10.4.5.3-1.

Regarding operation, it is contemplated that the phone 3 can operate for systems that use the code division multiple access (CDMA), frequency division multiple access (FDMA), and time division multiple access (TDMA) standards. Furthermore, it is contemplated that the phone 3 can operate in frequency bands used for wireless communications. For example, the phone 3 can be configured to receive and transmit data according to the Global System for Mobile Communications (GSM) standard which typically operates in the 900 MHz and 1800 MHz ranges.

Furthermore, the phone 3 can be configured to receive and transmit data according to the Personal Communications System (PCS) standard. In PCS systems, the phone 3 operates in a transmit band between 1850 MHz and 1910 MHz and a receive band between 1930 MHz and 1990 MHz. The phone 3 can also be configured to receive and transmit data according to the Advanced Mobile Phone Systems (AMPS) standard. In an AMPS system, the phone 3 operates in a transmit band between 824 MHz and 849 MHz and a receive band between 869 MHz and 894 MHz.

In addition, it is contemplated that in one embodiment, the phone 3 can be configured to operate as a dual-band phone and as a dual-mode phone. For example, the phone 3 can be configured to include a dual-band transmitter so that the phone 3 can operate both in the CDMA frequency bands and PCS frequency bands. In addition, the phone 3 can be configured as a dual-mode phone to operate in the CDMA mode or in a mode for AMPS communication devices.

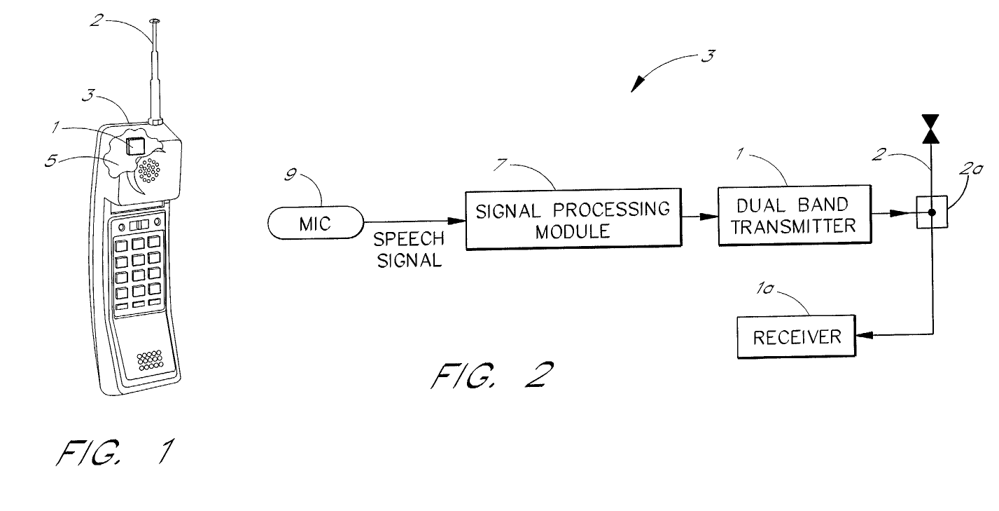

FIG. 2 illustrates an embodiment of the transmit path of the phone 3. Within the cellular phone 3, the transmitter module 1 and a processing module 7 are positioned on the motherboard 5 and interconnected between the antenna 2 and a microphone 9 of the phone 3. In the illustrated embodiment, the processing module 7 performs most speech and signal processing in a transmit direction, for example, voice encoding and channel encoding. A modulator, included either in the signal processing module 7 or the transmitter module 1, modulates a RF carrier of, for example, about 824 MHz with the processed speech signal. The carrier frequency of 824 MHz is selected from a transmit band defined for CDMA systems. The transmit band is approximately between 824 MHz and 849 MHz. For PCS systems, the RF carrier is selected from the transmit band between 1850 MHz and 1910 MHz as discussed above.

The receive path is indicated by means of a receiver module 1a which includes, for example, a radio frequency (RF) receiver. The transmitter module 1 and the receiver module 1 a are connected to the antenna 2 through an electronic switch 2a which connects the antenna 2 either to the transmitter module 1 or the receiver module 1a. The CPU of the phone 3 operates the electronic switch 2a in accordance with a transmission protocol to avoid, for example, that the receiver 1a receives a signal the transmitter module 1 emits. In cellular CDMA systems, for example, a duplexer ensures that the receiver 1a does not receive the signal emitted from the transmitter module 1.

FIG. 3 shows an exemplary block diagram of the transmitter module 1 shown in FIG. 2. Electrical circuits or devices such as the receiver module 1a and the transmitter module 1 can be implemented in a single-ended version or a differential version. The differential version is advantageously used to improve the electrical circuits with respect to noise and undesired signal components. In the differential version, the transmitter module 1 is connected to the signal processing module 7 through two differential lines. The differential lines are typically referred to as inverted and non-inverted, or “+” and “−”. The block diagram of FIG. 3, however, shows the transmitter module 1 in the single-ended version. Those skilled in the art will appreciate that a differential version can be implemented by adapting the components to receive, process and output signals on two lines.

The transmitter module 1 includes a modulator module 12 and an amplifier module 10. The modulator module 12 is connected between the signal processing module 7 and the amplifier module 10. The modulator module 12 includes mixer and driver stages as described below. In one embodiment, the amplifier module 10 is a multiple-stage amplifier operating as a power amplifier. An input 14 of the amplifier module 10 is connected to the modulator module 12 and an output 16 of the amplifier module 10 is connected to the antenna 2.

A controller 17 located within the phone 3 controls and monitors the modulator module 12 and the amplifier module 10. For instance, the controller 17 can be associated with a power management system of the phone 3. The power management system is responsible for controlling the power level with which the RF signals are transmitted. The power level depends, for example, on the distance between the phone 3 and a base transceiver station, and the characteristics of a propagation path between the phone 3 and the base transceiver station. The power level requirements are transmitted between the phone 3 and the base transceiver station by means of a communications protocol typically used in CDMA systems. The controller 17 can be the central processing unit (CPU) of the phone 3 or a subprocessor in communication with the CPU. In one embodiment, the power management system is implemented in a subprocessor which communicates with the CPU.

The modulator module 12 of the transmitter module 1 includes two mixer stages formed by mixers 18, 22 in combination with local oscillators 30, 31 respectively. In FIG. 3, the local oscillators 30, 31 are shown as being part of the modulator module 12. However, it is contemplated that the local oscillators 30, 31 can be located at other locations within the phone 3. Further, it is contemplated that the grouping into the modulator module 12 and the amplifier module 10 is arbitrarily and that this grouping is for descriptive purposes only.

The mixer 18 is configured as a QPSK modulator (Quadrature Phase Shift Keying) which receives “I” and “Q” components of a baseband signal from the signal processing module 7 and a signal LO1 from the local oscillator 30. In one embodiment, the local oscillator 30 is adjustable so that the signal LO1 has a frequency in a range of about 100 to 640 MHz. The mixer 18 (QPSK modulator) modulates the signal LO1 with the incoming baseband signal so that an intermediate frequency signal results (indicated as “IF” and hereinafter referred to as IF signal). The IF signal includes the desired intermediate frequency, but also undesired frequencies which may cause noise in the IF signal. The IF signal is fed to an amplifier 20 which is controlled by a control signal AGC generated by the controller 17. The controller 17 is connected to the amplifier 20 via a control line 20a.

The amplifier 20 is configured to have a variable gain which is adjusted by the control signal AGC thereby implementing an automatic gain controlled amplifier. In one embodiment, the amplifier 20 has a dynamic range of about 90 dB and the control signal AGC can have a DC voltage between 0.2 V and 2.5 V to control the gain of the amplifier 20.

The amplifier 20 outputs an amplified IF signal to a bandpass filter 21. The bandpass filter 21 has a filter characteristic selected to pass the intermediate frequency and to block the undesired frequencies to reduce noise in the IF signal. In one embodiment, the bandpass filter 21 has a passband of about +/− 650 kHz. In FIG. 3, the output of the bandpass filter 21 is indicated as “Filtered IF.”

The noise reduced IF signal is fed to the mixer 22. In one embodiment, the mixer 22 can be configured to have a controlled gain variation to calibrate and to compensate for any gain variation in the transmit path. The mixer 22 converts the IF signal to a RF signal using a signal LO2 generated by the local oscillator 31. In one embodiment, the signal LO2 has a frequency of about 955 MHz to 979 MHz. Similar to the mixer 18, the mixer 22 up-converts the IF signal and generates the RF signal comprises the desired radio frequency, but also undesired frequencies. The output of the mixer 22 is indicated as “RF.”

The RF signal is fed to a bandpass filter 24. The bandpass filter 24 has a filter characteristic selected to pass the desired radio frequency and to block the undesired frequencies to reduce noise in the RF signal. In one embodiment, the bandpass filter 24 has a passband of about 25 MHz. In FIG. 3, the output of the bandpass filter 21 is indicated as “Filtered RF.”

The filtered RF signal is fed to an amplifier 26 which is generally configured to amplify RF signals in the 800 MHz range. The amplifier 26 is a drive amplifier for the amplifier module 10. Because an amplifier may not be ideally linear, the amplifier 20 can add undesired frequency components to the RF signal. To eliminate these undesired frequency components from the RF signal, an optional bandpass filter 28 is connected between the amplifier 20 and the amplifier module 10.

In FIG. 3, the bandpass filter 28 is connected to the input 14 of the amplifier module 10 which amplifies the RF signal. The amplifier module 10 outputs the amplified RF signal at the output 16 connected to the antenna 2. The antenna 2 emits the RF signal in a conventional manner.

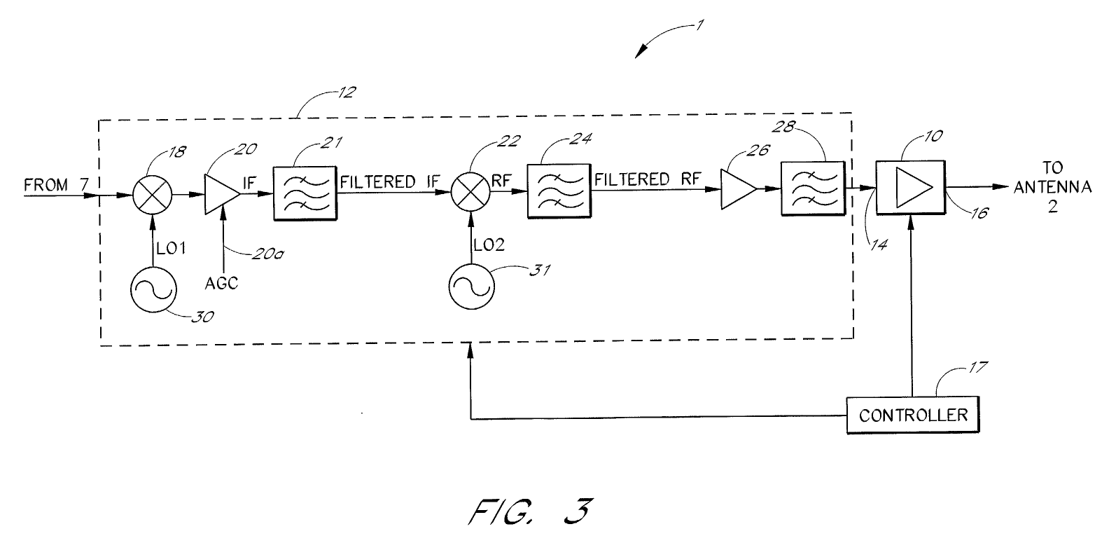

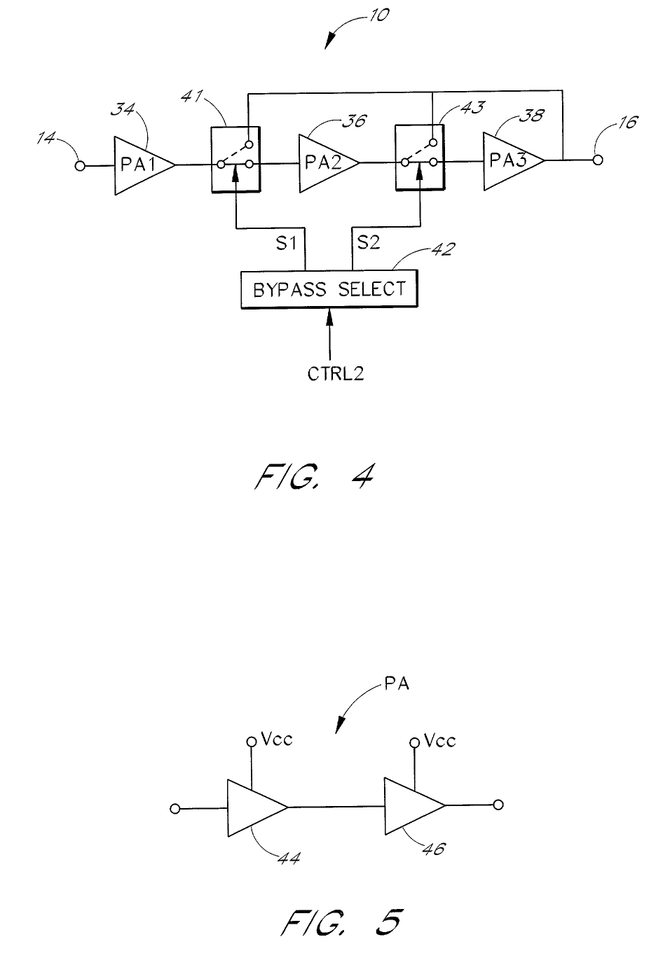

FIG. 4 shows an exemplary block diagram of the amplifier module 10. In the illustrated embodiment, the amplifier module 10 includes three amplifiers 34, 36, 38 (PA1, PA2, PA3). In one embodiment, the amplifiers 34, 36, 38 are power amplifiers which amplifying signals in the radio frequency range. Hereinafter, the amplifiers 34, 36, 38 are referred to as power amplifiers 34, 36, 38. However, it is contemplated that the invention generally can be used in connection with a variety of different types of amplifiers, and that the invention is not limited to applications using power amplifiers.

The power amplifiers 34, 36, 38 are arranged serially with respect to the input 14 and the output 16. The amplifier module 10 further includes switching circuits 41, 43 which are illustrated in FIG. 4 as two-pole switches. The switching circuits 41, 43 generally perform a controlled switching function, for example, between a first switching state and a second switching state. It is contemplated that the switching circuits 41, 43 can be implemented as hardware switches, such as gallium arsenide field-effect transistors or the like. The switches can be a discrete components or integrated as part of a monolithic microwave integrated circuit (MMIC), part of a radio frequency (RF) hybrid or implemented with a wide variety of semiconductor fabrication techniques. In other embodiments, the switching functions can be implemented by means of software routines and the like.

The switching circuit 41 is positioned between the power amplifier 34 and the power amplifier 36, and the switching circuit 43 is positioned between the power amplifier 34 and the power amplifier 38. In another embodiment, the switching circuit 41 is positioned in parallel with power amplifier 34 such that switch circuit 41 can selectively bypass power amplifier 36. In another embodiment, the switching circuit 43 is positioned in parallel with the power amplifier 38 such that switch circuit 43 can selectively bypass power amplifier 38.

Each switching circuit 41, 43 is controllable through a control signal S1, S2, respectively. In combination, the switching circuits 41, 43 allow to connect one, two or three of the power amplifiers 34, 36, 38 to the output 16 and, thus, to the antenna 2. By controlling the switching circuits 41, 43 to selectively bypass the power amplifiers 36, 38 four different amplifier circuits can be implemented, one at a time. The power amplifier 34 is always part of these amplifier circuits, but the power amplifiers 36, 38 can be selectively bypassed. In FIG. 4, the switching circuits 41, 43 are controlled so that in one embodiment the amplifier circuit includes all three power amplifiers 34, 36, 38.

The control signals S1, S2 are output from a selector 42 which receives a control signal CTRL2 generated by the controller 17. The control signal CTRL2 can be a one-bit word that selects the switching circuits 41, 43 via two outputs of the selector 42. Alternatively, the control signals S1, S2 can be generated directly by the controller 17 so that in this case the selector 17 is not necessary.

In one embodiment, the power amplifiers 34, 36, 38 are all powered up even though one or two power amplifiers 36, 38 are not part of a presently selected amplifier circuit. In another embodiment, the power amplifiers 36, 38 are only then powered up when they are part of the selected amplifier circuit.

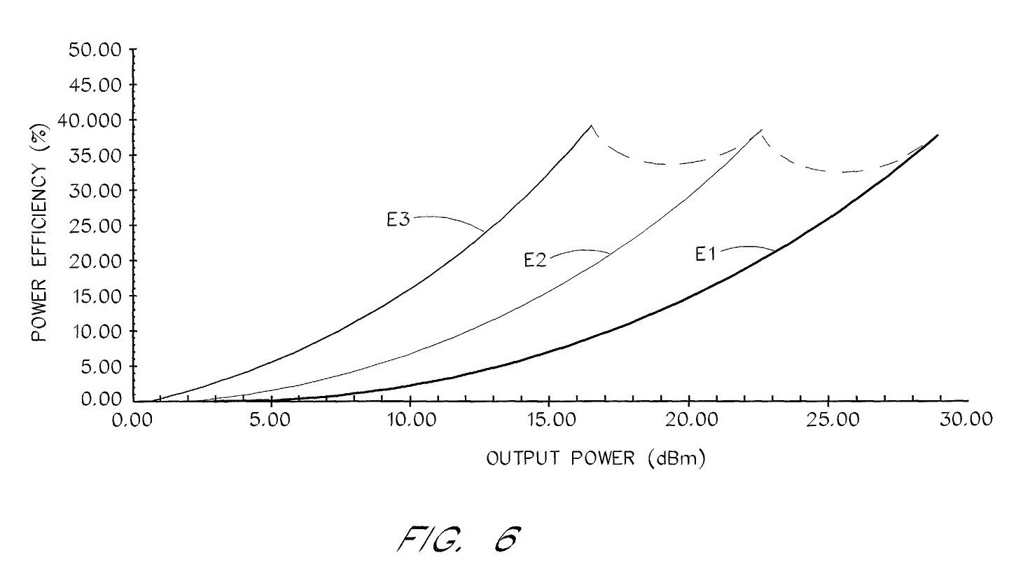

FIG. 5 schematically shows an internal structure of the power amplifiers 34, 36, 38. The power amplifiers 34, 36, 38 generally include a serial arrangement of two amplifiers 44, 46. Each amplifier 44, 46 is connected to the supply voltage VCC. In operation, the power amplifiers 34, 36, 38 consume electrical power which is proportional to the consumed current. The consumed current is an accurate indicator of the consumed power and the power efficiency. For a specific power amplifier, the power efficiency generally increases with increasing output power, as shown in FIG. 6.

FIG. 6 shows exemplary graphs, labeled as E1, E2, E3, illustrating power efficiencies of the power amplifiers 34, 36, 38, respectively. The power efficiencies (in %) are shown as functions of the output power (in dBm, referenced to a power of 1 mW). It is contemplated that the graphs E1, E2, E3 are representations of a variety of possible graphs, and that the graphs E1, E2, E3 are shown to explain an underlying principle of the invention.

As shown, the power efficiency generally increases with an increasing output power. For example, the power amplifier 34 has a power efficiency of about 15% at an output power of 20 dBm (graph E1). In case the output power is increased to about 25 dBm, the power efficiency increases to about 30%. The power efficiencies of the power amplifiers 36, 38 have similar characteristics. The power amplifier 36 has a power efficiency of about 15% at an output power of 15 dBm (graph E2). In case the output power is increased to about 20 dBm, the power efficiency increases to about 30%. The power amplifier 38 has a power efficiency of about 15% at an output power of 10 dBm (graph E3). In case the output power is increased to about 15 dBm, the power efficiency increases to about 30%.

If in one embodiment only the power amplifier 34 is part of the amplifier circuit and the power amplifiers 36, 38 are bypassed, the amplifier circuit has a power efficiency as described by the graph E1 alone. However, if one or more power amplifiers 36, 38 are added to the power amplifier 34, the power efficiency of this amplifier circuit is then determined by the power efficiencies of the individual power amplifiers 34, 36, 38. The power efficiencies superimpose to form the power efficiency of the amplifier circuit.

FIG. 6 illustrates the result of the superimposing power efficiencies by means of dashed lines connecting the graphs E1, E2, E3. The dashed lines represent the power efficiency of the amplifier circuit one or more power amplifiers 36, 38 are connected to the power amplifier 34. As illustrated, at a lower output power, e.g., 20 dBm, the power efficiency is higher than the power efficiency of the power efficiency (graph E1) of the power amplifier 34 alone. That is, the power efficiency has a relatively high value over a wide range of output power.

In case the output power is decreased, e.g., from 25 dBm to 20 dBm, the controller 17 detects the decreased power and connects the power amplifier 36 serially. The amplifier circuit formed by the serial combination of the power amplifiers 34, 36 has an improved power efficiency which covers a wider range than the power amplifier 34 alone would cover. Thus, by selectively adding or removing (bypassing) the power amplifiers 36, 38, the amplifier module 10 has an improved power efficiency over a wide range of output power.

Referring to FIGS. 4-6, the amplifier module 10 provides for an improved efficiency of the phone 3 which allows to improve the stand-by time and the talk time. Each power amplifier 34, 36, 38 is designed to operate with increased efficiency within different output power ranges. For example, in one embodiment the efficiency of the power amplifier 34 increases for a power range between 29 dBm and 19 dBm, the efficiency of the power amplifier 36 increases for a power range between 20 dBm and 9 dBm, and the efficiency of the power amplifier 38 increases for a power range between 10 dBm and −1 dBm.

As shown in FIG. 6, the power efficiency of the power amplifiers 34, 36, 38 reaches up to approximately 35%. As described above, the controller 17 controls the power level with which the RF signal has to be transmitted. The controller 17 determines which power amplifier 34, 36, 38 is designed for increased efficiency at the presently required power level and activates the corresponding power amplifier 34, 36, 38 until the power level requirement changes again. As soon as the power level requirement changes, the controller 17 immediately activates the power, amplifier 34, 36, 38 which operates more efficiently for the new power level. The switching between the power amplifiers 34, 36, 38 occurs so that the user of the phone 3 does not typically notice the switching.

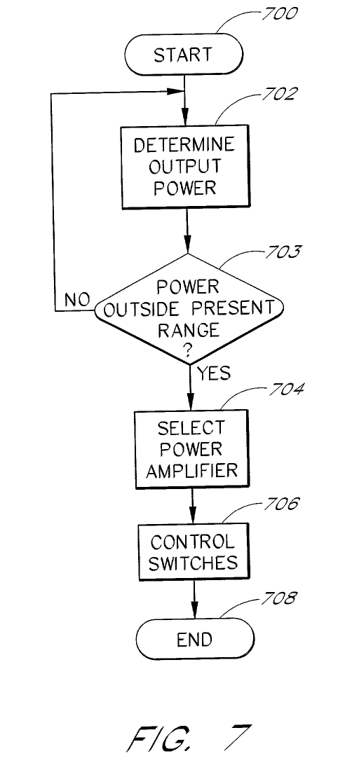

FIG. 7 shows a flow chart of a control procedure for the amplifier module 10. At power up of the phone 3, the procedure is reset and initialized, as represented in start block 700.

Proceeding to step 702, the procedure determines the output power at which the phone 3 currently emits the RF signals. As described above, the output power is determined, inter alia, by the distance between the phone 3 and the transceiver station. The controller 17 or the phone's CPU processes a signal, for example, received from the transceiver station which requires the phone 3, for example, to decrease the output power for about 5 dBm.

Proceeding to step 703, the procedure compares the determined output power in step 702 with the power range of the currently active power amplifier 34, 36, 38. If the determined output power is within the power range of the active power amplifier 34, 36, 38, the procedure proceeds along the NO branch back to step 702. If the determined output power is outside the power range of the active power amplifier 34, 36, 38, the procedure proceeds along the YES branch to step 704.

Proceeding to step 704, the procedure uses the signal indicating the 5-dBm decrease to correlate the “new” output power with power-efficiency data. The power-efficiency data represents combinations of the power amplifiers 34, 36, 38 which increase the power efficiency of the phone 3.

Proceeding to step 706, the procedure controls the switching circuits 41, 43 to implement the combination of power amplifiers 34, 36, 38 determined in step 704. When the switching circuits 41, 43 are set, the procedure ends as indicated in block 708.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

What is claimed is:

1. A wireless communications device comprising:
a modulator module configured to convert a baseband signal to a radio frequency signal;
an amplifier module which receives the radio signal and generates an amplified output signal, the amplifier module comprising:
a first amplifier with an input in communication with the radio frequency signal, the first amplifier configured to generate a first amplified signal at increased efficiency in a first operational range;
a second amplifier with an input in communication with the output of the first amplifier, the second amplifier configured to amplify the first amplified signal at increased efficiency in a second operational range to create a second amplified signal, wherein the second operational range is different than the first amplification range;
a third amplifier with an input in communication with the output of the second amplifier, the third amplifier configured to amplify the second amplified signal at increased efficiency in a third operational range to create a third amplified signal, wherein the third operational range is different than the first and second operational ranges;
a first switch positioned to bypass the second amplifier;
a second switch positioned to bypass the third amplifier;
a bypass selector in communication with the first and second switches, the bypass selector configured to output the first, second or third amplified signal as an amplified output signal; and
a control module in communication with the bypass selector, the control module configured to control the switch based on a desired operational level.

2. The device of claim 1, wherein the first operational range is between 29 dBm and 19 dBm.

3. The device of claim 1, wherein the second operational range is between 20 dBm and 9 dBm.

4. The device of claim 1, wherein the third operational range between 10 dBm and −1 dBm.

5. The device of claim 1 wherein the bypass selector receives a digital control value.

6. The device of claim 1 wherein the first amplifier further comprises two serially connected amplifiers.

7. An amplification module comprising:
an input for receiving an input signal;
at least a first amplifier in communication with the input, the first amplifier configured to amplify the input signal to generate a first amplified signal at increased efficiency within a first operational range;
a first switch in communication with the first amplifier, the first switch configured to output the first amplified signal as an amplified output signal;
at least a second amplifier in communication with the first amplified signal, the second amplifier configured to amplify the first amplified signal to generate a second amplified signal at increased efficiency in a second operational range, wherein the second operational range is different than the first operational range; and
a second switch in communication with the second amplifier, the second switch configured to output the second amplified signal as an amplified output signal.

8. The device of claim 7 wherein the first amplifier operates with increased efficiency for an operational range between 29 dBm and 19 dBm.

9. The device of claim 7 wherein the second amplifier operates with increased efficiency for an operational range between 20 dBm and 9 dBm.

10. The device of claim 7 wherein the first switch places the first amplified signal into communication with the second amplifier.

11. The device of claim 7 further comprising a selector, the selector configured to selectively vary the first and second switches.

12. The device of claim 7, further comprising at least a third amplifier in communication with the second amplified signal, the third amplifier configured to amplify the second amplified signal to generate a third amplified signal at increased efficiency in a third operational range, wherein the third operational range is different than the first and second operational ranges.

13. An amplifier circuit comprising:
an input for receiving an input signal;
at least a first amplifier in communication with the input, the first amplifier comprising structure which generates a first amplified signal at increased efficiency within a first operation range;
at least a second amplifier, the second amplifier comprising structure which amplifies the first amplified signal at increased efficiency within a second operational range to generate a second amplified signal; and
at least one selector circuit in communication with the first and second amplifiers, the selector circuit configured to selectively generate an amplified output signal which comprises at least a portion of the first or second amplified signal.

14. The device of claim 13 wherein the amplified output signal comprises a least a portion of the first and second amplified signals.

15. The device of claim 13 wherein the input signal is approximately 800 megahertz.

16. The device of claim 13 wherein the input signal is approximately 1900 megahertz.

17. The device of claim 13 wherein the amplified output signal is a wireless communications signal.

18. The device of claim 13 wherein the amplified output signal is a CDMA communications signal.

19. The device of claim 13 wherein the amplified output signal is a GSM communications signal.

20. The device of claim 13 wherein the amplified output signal is a PCS communications signal.

21. The device of claim 13 wherein the amplified output signal is an AMPS communications signal.

22. An amplifier circuit comprising:
a first means for amplifying an input signal to generate a first amplified signal at increased efficiency within a first operational range;
a second means for amplifying the first amplified signal to generate a second amplified signal at increased efficiency within a second operational range; and
a third means for selectively enabling the output of at least one of the first and second amplified signals.

23. The amplifier circuit of claim 22 further comprising a fourth means for selectively enabling at least one of the first and second amplifiers.

24. The amplifier circuit of claim 23 wherein the fourth means enables at least one of the first and second amplifiers based on a desired operational range.

25. The method of operating a wireless communications device comprising the acts of:
converting a baseband signal to a radio frequency signal;
amplifying with a first amplifier, the radio frequency signal at increased efficiency in a first operational range to produce a first amplified signal;
amplifying with a second amplifier, the first amplified signal at increased efficiency in a second operational range to produce a second amplified signal, wherein the second operational range is different than the first amplification range;
amplifying with a third amplifier, the second amplified signal at increased efficiency in a third operational range to produce a third amplified signal, wherein the third operational range is different than the first and second operational ranges; and
selectively outputting based on a desired operational level, the first, second or third amplified signals as an amplified output signal.

26. The method of claim 25 wherein the first operational range is between 29 dBm and 19 dBm.

27. The method of claim 25 wherein the second operational range is between 20 dBm and 9 dBm.

28. The method of claim 25 wherein the third operational range is between 10 dBm and −1 dBm.

29. The method of claim 25 further comprising the act of selectively activating the first, second or third amplifier.

30. The method of claim 28 further comprising the act of processing a digital control value to selectively activate at least one of the first, second or third amplifiers.

31. A method of amplifying an input signal comprising the acts of:
amplifying an input signal to generate a first amplified signal at increased efficiency within a first operational range;
amplifying the first amplified signal to generate a second amplified signal at increased efficiency in a second operational range, wherein the second operational range is different than the first operational range; and
selectively enabling the output of at least one of the first and second amplified signals in response to a desired amplification level.

32. The method of claim 31 further comprising the act of selectively activating at least one of the first and second amplifiers.

33. The method of claim 31 wherein the first operational range is between 29 dBm and 19 dBm.

34. The method of claim 31 wherein the second operational range is between 20 dBm and 9 dBm.

35. The method of claim 31 wherein the act of selectively enabling selects either the first or second amplified signal.

36. The method of claim 31 wherein the act of selectively enabling combines the first and second amplified signals.

37. The method of claim 31 wherein the input signal is approximately 800 megahertz.

38. The method of claim 31 wherein the input signal is approximately 1900 megahertz.

39. The method of claim 31 wherein the amplified output signal is a wireless communications signal.

40. The method of claim 31 wherein the amplified output signal is a CDMA communications signal.

41. The method of claim 31 wherein the amplified output signal is a GSM communications signal.

42. The method of claim 31 wherein the amplified output signal is a PCS communications signal.

43. The method of claim 37 wherein the amplified output signal is an AMPS communications signal.
